(19) United States
(12) Patent Application Publication
(10) Pub. No.: US 2014/0333428 A1
(43) Pub. Date: Nov. 13, 2014

(54) Lighting System For Monitoring Light Emitting Devices

(71) Applicant: NORTH AMERICAN LIGHTING, INC., Farmington Hills, MI (US)

(72) Inventor: Kevin Markell, Davison, MI (US)

(73) Assignee: North American Lighting, Inc., Farmington Hills, MI (US)

(21) Appl. No.: 13/891,642

(22) Filed: May 10, 2013

(51) Int. Cl. B60Q 1/34

(52) U.S. Cl. CPC B60Q 1/34
USPC 340/475; 340/468

(57) ABSTRACT

A lighting system is provided with a plurality of devices that are disposed within a lamp assembly and configured to emit light in response to receiving electrical power from a power source. The detector is coupled to the plurality of devices and is configured to monitor an electrical characteristic associated with the plurality of devices. The detector is also configured to generate an output signal that is indicative of a discontinuity within the plurality of devices in response to the electrical characteristic being less than a threshold value. The lighting system also includes a controller that is coupled to the detector. The controller is configured to receive input indicative of a turn signal status and a rear closure position and to enable the detector in response to the rear closure position being closed and the turn signal status being on.

### TECHNICAL FIELD

One or more embodiments relate to a lighting system for monitoring one or more light emitting devices.

### BACKGROUND

Automotive vehicles include lighting systems for the rear of the vehicle that include lamps that function as tail lights, brake lights, turn signals, and back-up or reverse lights. The color of light emitted by vehicle lamps is largely standardized by longstanding international conventions. Generally, but with some regional exceptions, lamps facing rearward emit red light, lamps facing sideward and turn signals emit amber light, and lamps facing frontward emit white or selective yellow light.

Tail lamps produce red light, and are typically wired such that they illuminate whenever the vehicle's front lights are illuminated. Brake lamps also produce red light and are wired such that they illuminate when a driver depresses a brake pedal. Rear facing turn signal lamps produce red or amber light and are wired such that they illuminate light when a driver actuates a turn signal handle. The tail lamps, brake lamps and turn signal lamps may be combined in a rear combination lamp (RCL).

Some vehicles include rear lamps that are mounted to a rear closure, such as trunk or lift gate. Such lamps are disabled when the trunk/lift gate is ajar so that they do not emit light. Disabling such rear lamps, prevents red light from being visible from the front of the vehicle while it is moving forward. For example, a driver who is hauling large cargo in a sport utility vehicle (SUV) may leave the lift gate open to provide additional space. However, a RCL mounted to the lift gate must be disabled so that the red light is not visible from the front of the vehicle.

Automotive lighting systems may include circuitry for monitoring the performance of the light emitting devices. For example, many automotive lighting systems monitor the light emitting devices used for turn signals for discontinuities, such as open circuit conditions.

### SUMMARY

In one embodiment, a lighting system is provided with a lamp assembly for being positioned on an external surface of a vehicle. The lighting system includes a plurality of devices and a detector. The plurality of devices are disposed within the lamp assembly and are configured to emit light in response to receiving electrical power from a power source. The detector is coupled to the plurality of devices and is configured to monitor an electrical characteristic associated with the plurality of devices. The detector is also configured to generate an output signal that is indicative of a discontinuity within the plurality of devices in response to the electrical characteristic being less than a threshold value. The lighting system also includes a controller that is coupled to the detector. The controller is configured to receive input indicative of a turn signal status and a rear closure position and to enable the detector in response to the rear closure position being closed and the turn signal status being on.

In another embodiment, a lighting system is provided with a series of circuit boards for being positioned about a vehicle. The lighting system includes a plurality of LED strings mounted to the series of circuit boards and a controller connected to the plurality of LED strings in a daisy chain configuration. The lighting system also includes a plurality of detectors mounted to the series of circuit boards and remote from the controller. Each detector is coupled to one of the plurality of LED strings for monitoring an electrical characteristic. Wherein the controller is configured to receive input indicative of a rear closure position and to disable the plurality of detectors in response to the rear closure position being open.

In yet another embodiment, a lighting system is provided with a plurality of LEDs that are configured to emit light in response to receiving electrical power from a power source. The lighting system includes a detector and a controller. The detector is coupled to the plurality of LEDs and configured to monitor an electrical characteristic associated with the LEDs, and to generate an output signal indicative of a discontinuity within the plurality of LEDs in response to the electrical characteristic being less than a threshold value. The controller is coupled to the detector, and configured to receive input indicative of a rear closure position, and to disable the detector in response to the rear closure position being open.

As such, the lighting system provides advantages over existing systems by monitoring LEDs for discontinuities using detectors that are selectively enabled. By disabling the detectors when they are not in use, the lighting system reduces a potential LED glow condition in which the LEDs may emit light even when they are not “enabled”. Further, the detectors are mounted in proximity to the LEDs and remote from the controller to reduce wiring content.

### BRIEF DESCRIPTION OF THE DRAWINGS

FIG. 1 is a rear perspective view of a vehicle having a lighting system for monitoring one or more light emitting devices according to one or more embodiments;

FIG. 2 is a side view of the vehicle of FIG. 1, illustrating a lift gate in an open position;

FIG. 3 is a schematic diagram of the lighting system of FIG. 1 according to one or more embodiments, illustrating local monitoring circuits and the light emitting devices positioned on a common board;

FIG. 4 is a circuit diagram illustrating a portion of the lighting system of FIG. 3;

FIG. 5 is a schematic diagram of the lighting system of FIG. 3, illustrating the light emitting devices distributed amongst multiple boards;

FIG. 6 is a schematic diagram of the lighting system of FIG. 1 according to one or more embodiments, illustrating remote monitoring circuits and the light emitting devices positioned on a common board;

FIG. 7 is a circuit diagram illustrating a portion of the lighting system of FIG. 6;

FIG. 8 is a schematic diagram of the lighting system of FIG. 6, illustrating the light emitting devices distributed amongst multiple boards; and

FIG. 9 is a flow chart illustrating a method for monitoring the light emitting devices according to one or more embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, RAM, ROM, EPROM, EEPROM, or other suitable variants thereof) and software which co-act with one another to perform any number of the operation(s) as disclosed herein.

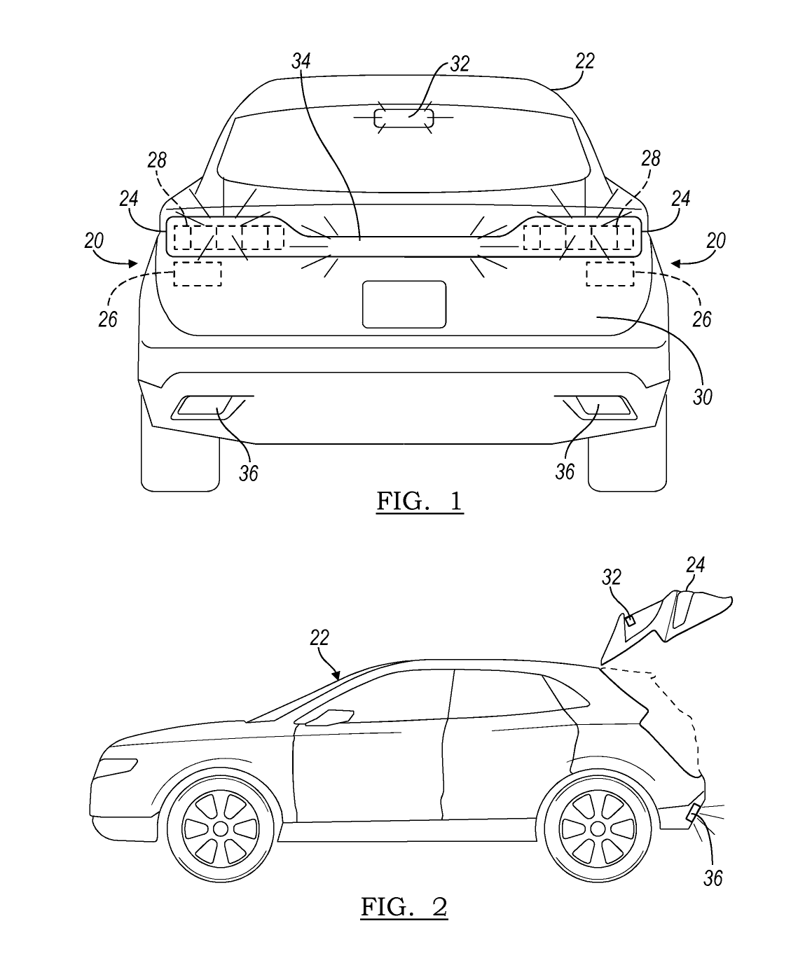

With reference to FIG. 1, a lighting system is illustrated in accordance with one or more embodiments, and is generally illustrated by numeral 20. The lighting system 20 is contained within a vehicle 22 and includes light emitting devices that are disposed within a rear combination lamp (RCL) assembly 24. In one or more embodiments, the lighting system 20 is fully contained within the RCL assembly 24. The illustrated embodiment depicts two RCL assemblies 24, where each RCL assembly 24 includes a lighting system 20. However, other embodiments contemplate a single lighting system 20 that is distributed between the two RCL assemblies 24. The lighting system 20 includes a module 26 and a plurality of light emitting devices 28. The light emitting devices 28 include light emitting diodes (LEDs) 28, according to one or more embodiments. The module 26 may be referred to as a LED driver module (LDM) 26.

The RCL assembly 24 is mounted to a rear closure, such as a lift gate 30 and includes LEDs 28 that are configured for tail lighting, brake lighting and turn signal lighting. The vehicle 22 may include other lamps that are also mounted to the lift gate 30, such as a center high mount stop lamp (CHMSL) 32 and a rear applique lamp (RAPL) 34. The CHMSL 32 is intended to provide a deceleration warning to following drivers whose view of the vehicle's left and right RCL assemblies 24 is blocked by interceding vehicles. The RAPL 34 is provided for aesthetic purposes and may be illuminated in a custom pattern. A redundant module lamp (RML) 36 is mounted to a lower portion of the vehicle 22. As depicted in FIG. 1, the RCL 24, CHMSL 32 and RAPL 34 may be activated and the RML 36 is deactivated, when an ignition position is on, and the lift gate 30 is closed. However, as depicted in FIG. 2, the RCL 24, CHMSL 32 and RAPL 34 are deactivated and the RML 36 is activated, when an ignition position is on, and the lift gate 30 is ajar or open.

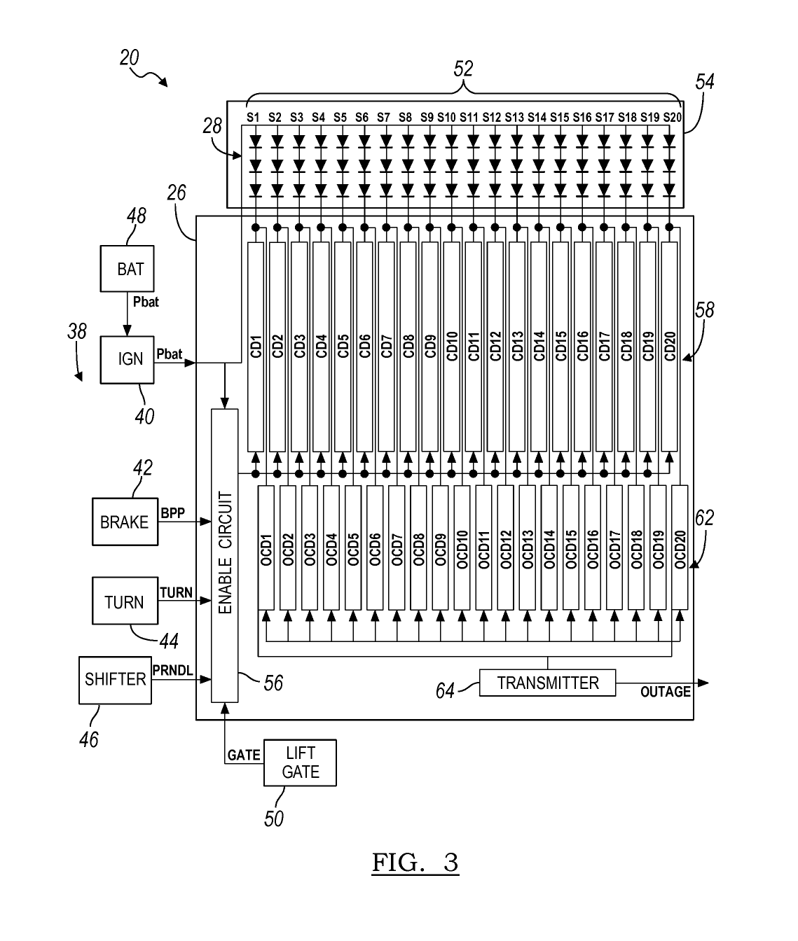

With reference to FIG. 3, the vehicle includes a plurality of driver controls 38 that provide information to the lighting system 20 that is indicative of present and future driving conditions. The lighting system 20 controls the LEDs 28 to communicate this information to pedestrians and to drivers of other nearby vehicles (not shown). The driver controls 38 include an ignition system 40, a brake system 42, a turn system 44, and a shifter system 46. The LDM 26 communicates with the driver controls 38, and other vehicle systems, controllers and sensors over one or more wired or wireless connections. The illustrated embodiment depicts the LDM 26 communicating directly with the driver controls 38. However, in other embodiments, the LDM 26 may communicate indirectly with the driver controls 38 using a common bus protocol (e.g., CAN or LIN).

The vehicle includes an electrical storage device, such as a battery 48 for storing electrical energy. The battery 48 supplies electrical power (P_{bat}) to various vehicle systems (e.g., the lighting system 20). The ignition system 40 includes an ignition switch (not shown) that is connected between the battery 48 and the LDM 26. The ignition switch electrically connects the LDM 26 to the battery 48 for receiving P_{bat} when the ignition key (not shown) is in an “on” or “run” position. The ignition switch also disconnects the LDM 26 from the battery 48 when the ignition key is in an “off” position. Although described with reference to a single battery 48 and an ignition system having a key, the lighting system 20 is compatible with vehicles having multiple batteries (e.g., hybrid vehicles) and/or keyless ignition systems (not shown).

The brake system 42 includes a brake sensor (not shown) that provides an output signal (BPP) that is indicative of a brake pedal position. The brake sensor may be a switch (e.g., a stop lamp switch) or a sensor (e.g., a potentiometer). The LDM 26 receives the BPP signal and controls the LEDs 28 associated with brake lighting in response to the BPP signal.

The turn system 44 includes a turn sensor (not shown) that provides an output signal (TURN) that is indicative of a turn signal status (e.g., on/off). The vehicle may include a handle or “stalk” that is coupled to a steering column (not shown). The turn sensor provides the TURN signal based on the position of the handle. The LDM 26 receives the TURN signal and controls the LEDs 28 associated with turn signal lighting in response to the TURN signal.

The shifter system 46 includes a shift sensor (not shown) that provides an output signal (PRNDL) that is indicative of a transmission gear selection. The shift sensor provides the PRNDL signal based on the position of a shift lever, which corresponds to the transmission gear selection. The LDM 26 receives the PRNDL signal and controls the LEDs 28 associated with park, drive, and reverse lighting in response to the PRNDL signal.

The vehicle also includes a lift gate system 50 that includes the lift gate 30 (FIG. 2) and a lift gate sensor (not shown). The lift gate sensor provides an output signal (GATE) that is indicative of the position of the lift gate 30. The LDM 26 receives the GATE signal and controls various LEDs 28 in response to the GATE signal. For example, as described above with reference to FIGS. 1 and 2, the LDM 26 may deactivate the LEDs 28 within the RCL 24 when the GATE signal indicates that the lift gate 30 is ajar or open.

The LEDs 28 are arranged in parallel paths or “strings” 52. The lighting system 20 includes twenty LED strings 52 (“S1, S2 . . . S20”), and each LED string 52 includes three LEDs 28, according to the illustrated embodiment. The LEDs 28 are mounted to a circuit board, such as a printed circuit board (PCB) 54. For applications where the LEDs 28 are located in close proximity, a common PCB 54 may be used for all of the LEDs 28.

The lighting system 20 includes circuitry for controlling the LEDs 28. The LDM 26 includes a controller, such as an enable circuit 56 and a series of current drivers 58. The enable circuit 56 receives the input signals (P_{bat}, BPP, TURN, PRNDL, and GATE) from the driver controls 38 and the lift gate system 50. The enable circuit 56 includes discrete components (not shown) for enabling the current drivers 58 based on the input signals. In the illustrated embodiment, the enable circuit 56 enables all the current drivers 58 and corresponding LED strings 52 together. However, in other embodiments of the lighting system 20, the enable circuit includes a microprocessor and memory (not shown), and is configured to enable the LED strings 52, or a subset of the LED strings 52, based on a comparison of the input signals to predetermined instructions stored within the memory. A current driver 58 (“CD1, CD2 . . . CD20”) is connected to each LED string (S1-S20), according to the illustrated embodiment.

The lighting system 20 also includes circuitry for monitoring the performance of the LEDs 28. The lighting system 20 includes a series of open circuit (OC) detectors 62 and a transmitter 64 that are located within the LDM 26, according to the illustrated embodiment. An OC detector 62 (“OCD1, OCD2 . . . OCD20”) is connected to each LED string (S1-S20) for monitoring for a discontinuity, such as an open circuit condition within that particular LED string 52. The transmitter 64 is connected to each OC detector 62, and generates a signal (OUTAGE) that indicates that at least one of the LED strings 52 has an open circuit condition. The transmitter 64 may provide the OUTAGE signal to other vehicle controllers, such as a body control module (not shown).

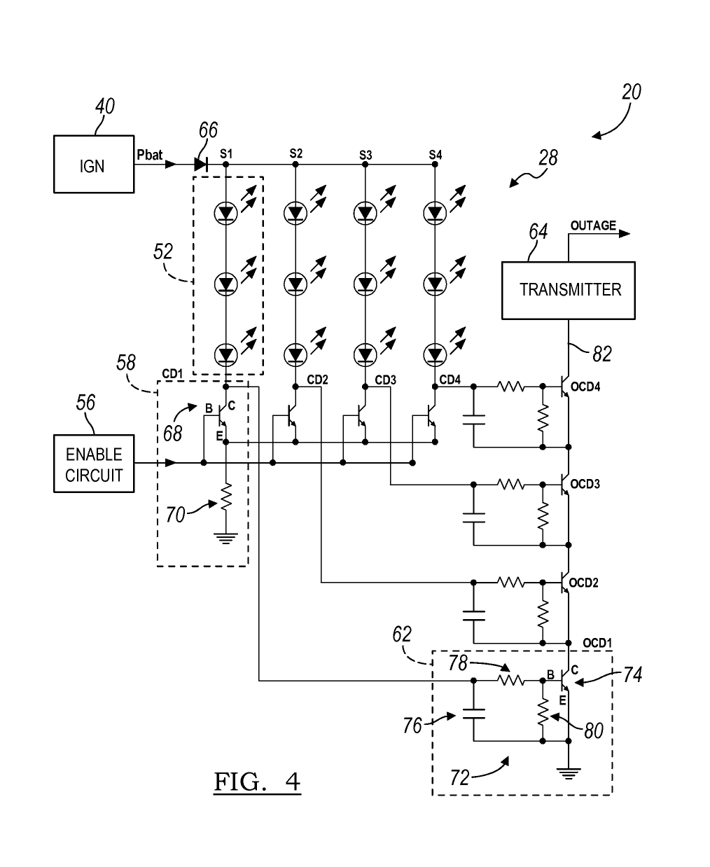

FIG. 4 is a circuit diagram illustrating a portion of the lighting system of FIG. 3. The battery power (P_{bat}) is provided to the LED strings 52 through an input diode 66. LED strings S1, S2, S3 and S4 are illustrated in FIG. 4. The input diode 66 prevents current from flowing back towards the battery 48 (FIG. 3).

The current driver 58 maintains a generally constant current through its corresponding LED string 52. Four current drivers (CD1, CD2, CD3, and CD4) are illustrated connected to four corresponding LED strings (S1, S2, S3, and S4) in FIG. 4. Each current driver 58 includes a switch 68 (e.g., a transistor). The transistor 68 is an NPN bipolar junction transistor (BJT) according to the illustrated embodiment. The enable circuit 56 is connected to the base of each transistor 68 to control or “drive” a constant current through the LED string 52. The enable circuit 56 controls the LED strings 52 together in the illustrated embodiment. However, in other embodiments of the lighting system 20, the enable circuit 56 is configured to control the LED strings 52 individually. The current supplied to the LEDs 28 corresponds to the brightness of the light emitted by each LED 28. Therefore, by driving the LED strings 52 with a constant current, the brightness of each LED 28 is generally the same. The emitter of each transistor 68 is connected to ground through a common resistor 70. Although the enable circuit 56 is described as including a BJT, other embodiments of the enable circuit 56 contemplate other electronic switches (e.g., MOSFETs, IGBTs, Relays, etc.).

Each OC detector 62 monitors an electrical characteristic (e.g., current and voltage) of its corresponding LED string 52 for a discontinuity, such as an open circuit condition. An open circuit condition indicates that no current is flowing through the LED string 52, and therefore the LEDs 28 of the LED string 52 are not emitting any light. Each OC detector (OCD1-OCD4) is connected to a node between a cathode of a corresponding LED string (S1-S4) and a corresponding current driver (CD1-CD4). The current driver 58 isolates each LED string 52, such that the OC detector 62 monitors the electrical characteristics of that individual LED string 52. The OC detector 62 includes a low pass filter, such as an RC circuit 72 and a switch, such as a transistor 74.

The RC circuit 72 functions as a low pass filter and as a bias for the transistor 74, according to one or more embodiments. The RC circuit 72 includes a capacitor 76, a first resistor 78 and a second resistor 80. The RC circuit 72 is connected between the LED string 52 and the base of the transistor 74. The collector of the transistor 74 is connected to the emitter of a transistor 74 of an adjacent OC detector 62. The collector of each transistor 74 is also connected to a common line 82, such that the transistors 74 collectively provide a NAND gate. A NAND gate (Negated AND or NOT AND) is a logic gate which produces an output that is False only if all its inputs are True. A LOW (False) output results only if all of the inputs to the gate are HIGH (True); and a HIGH (True) output if any of the inputs are LOW (False). The common line 82 is maintained at a low voltage (LOW) when none of the OC detectors detect an open circuit. However, if any of the OC detectors (OCD1-OCD4) detect an open circuit in their respective LED string (S1-S4), then the transistor 74 of that OC detector 62 will open and cause the common line 82 to float to a high voltage (HIGH). Thus, each OC detector 62 is configured to monitor the current associated with a corresponding LED string 52 and to generate an output signal (HIGH voltage) that is indicative of a discontinuity within the LED string 52 in response to the current being less than a threshold value (e.g., 50 μA), or being equal to approximately zero amps. The transmitter 64 is connected to the common line 82, and the transmitter 64 will provide a corresponding OUTAGE signal when the common line is high. Although the OC detector 62 is described as including an RC circuit and a BJT, other embodiments of the OC detector 62 contemplate other low pass filters (e.g., RL circuits, LC circuits, and active circuits) and other electronic switches (e.g., Relays).

The LEDs 28 may emit light at a low level when their LED string 52 is not enabled. The LED strings 52 receive P_{bat} when the ignition switch 40 is on. The current driver 58 disables an LED string 52 by controlling the transistor 68 to create an open circuit between the collector and the emitter of the transistor 68. However, even when a LED string 52 is “disabled”, the corresponding OC detector 62 is enabled, and therefore current may flow through a disabled LED string 52 (e.g., S1) and through the RC circuit 72 of the corresponding OC detector (e.g., OCD1) to ground. This current flow path results in the LEDs 28 emitting light at a reduced level (“LED glow”). Such LED glow may be acceptable during most driving conditions. However, if the vehicle is being driven in a forward direction with the lift gate open (as shown in FIG. 2), then the rear lamps could emit red light in a forward direction, and such LED glow would not be acceptable in this driving condition.

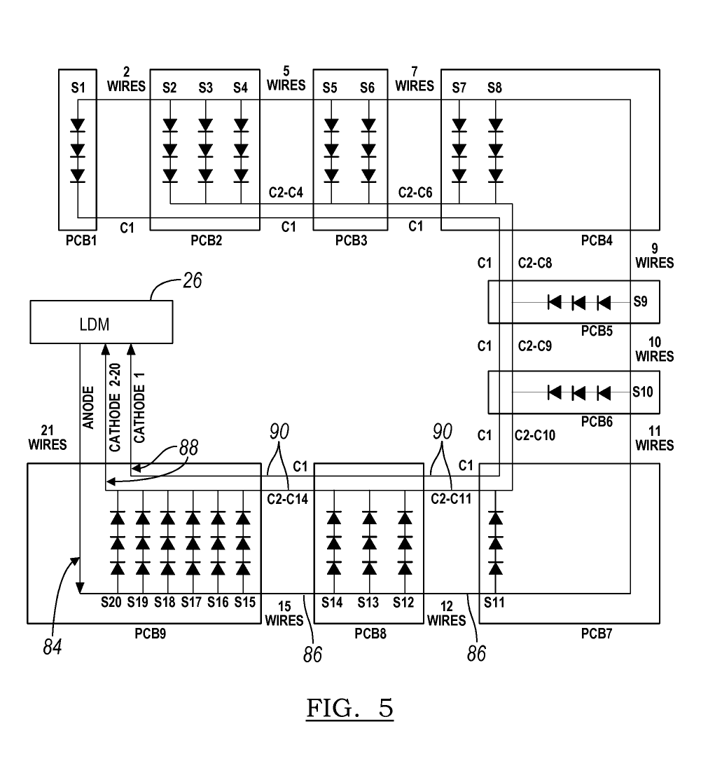

With reference to FIG. 5, the LEDs 28 may be distributed amongst multiple circuit boards 54 in a daisy chain configuration. PCBs are generally planar structures. However, vehicle lamps, such as the RCL 24 (FIG. 1) may be contoured. Multiple small PCBs 54 may be easier to position or package within a contoured lamp, than a large planar PCB. FIG. 5 depicts the twenty LED strings (S1-S20) of FIG. 3, distributed amongst nine PCBs (“PCB1-PCB9”) which are connected to the LDM 26 in a daisy chain configuration. The PCBs 54 include different numbers of LED strings 52. For example, in the illustrated embodiment, PCB1 includes one LED string (S1), and PCB9 includes six LED strings (S15-S20). Distributing the LED strings S2 amongst multiple PCBs 54 accommodates large and/or contoured lamp assemblies. However, such distributed PCBs 54 also increase the number of wires and associated costs, for connecting the PCBs 54 to the LDM 26.

For example, a power line 84 provides P_{bat} to the anode of the first LED 28 of each LED string 52. A power line jumper wire 86 connects each PCB 54 to an adjacent PCB 54. Therefore eight additional power line jumper wires 86 are used to connect the power line 84 between the LDM 26 and the nine PCBs shown in FIG. 5, as compared to the common PCB shown in FIG. 3.

Also, since the OC detector (shown in FIGS. 3 and 4) is located within the LDM 26, a return line 88 is connected between the cathode (“C1-C20”) of the last LED 28 of each LED string 52 (S1-S20) and the LDM 26. A return line jumper wire 90 connects each PCB 54 to an adjacent PCB 54. The return line 88 for C1 (LED string S1) which is located on PCB1, includes eight additional return line jumper wires 90 as compared to the configuration shown in FIG. 3. Additionally, the return line 88 for C2 (LED string S2) which is located on PCB2, includes seven additional return line jumper wires 90 as compared to the configuration shown in FIG. 3. For simplicity, the jumper wires 90 for C2-C4 are illustrated as one line between PCB2 and PCB3 in FIG. 3, however each LED string 52 includes its own jumper wire 90. For example, there is one power line jumper wire 86 and one return line jumper wire 90 between PCB 1 and PCB2; there is one power line jumper wire 86 and five return line jumper wires 90 between PCB2 and PCB3; and there is one power line jumper wire 86 and twenty return line jumper wires 90 (C1-C20) between PCB9 and the LDM 26. For illustrative purposes, the total number of jumper wires 86, 90 between each pair of adjacent PCBs is denoted as “#Wires” in FIG. 5. Thus by distributing the LEDs 28 over nine PCBs in a daisy chain configuration, seventy-one additional jumper wires 86, 90 are used, as compared to the common PCB configuration shown in FIG. 3.

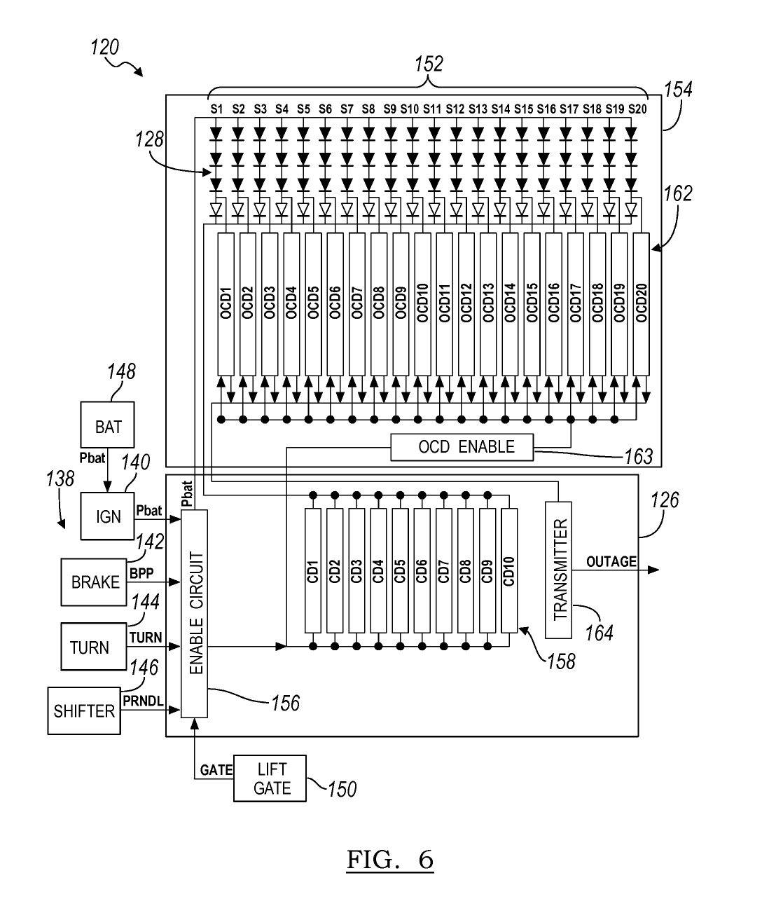

With reference to FIG. 6, a lighting system is illustrated in accordance with one or more embodiments, and is generally illustrated by numeral 120. The lighting system 120 includes a plurality of LEDs 128, and a LDM 126. The lighting system 120 is similar to the lighting system 20 described above with reference to FIGS. 3-5, however the lighting system 120 includes modifications to address LED glow and to reduce wiring content.

The vehicle includes a plurality of driver controls 138, including an ignition system 140, a brake system 142, a turn system 144 and a shifter system 146 that provide information (P_{bat}, BPP, TURN, PRNDL) to the lighting system 120. The vehicle includes an electrical storage device, such as a battery 148 for storing electrical energy. The battery 148 supplies electrical power (P_{bat}) to various vehicle systems (e.g., the lighting system 120). The ignition system 140 includes an ignition switch (not shown) that electrically connects the LDM 126 to the battery 148 when the ignition key is in an “on” position, and also disconnects the LDM 126 from the battery 148 when the ignition key is in an “off” position. The vehicle also includes a lift gate system 150 that includes the lift gate 30 (FIG. 2) and a lift gate sensor (not shown). The lift gate sensor provides an output signal (GATE) that is indicative of the position of the lift gate 30. The LDM 126 receives the GATE signal and controls various LEDs 128 in response to the GATE signal.

The LEDs 128 are arranged in parallel paths or “strings” 152. The lighting system 120 includes twenty LED strings 152 (S1, S2 . . . S20), and each LED string 152 includes three LEDs 128, according to the illustrated embodiment. The LEDs 128 are mounted to a circuit board, such as a PCB 154. As shown in FIG. 6, for applications where the LEDs 128 are located in close proximity, a common PCB 154 may be used for all of the LEDs 128.

The lighting system 120 includes circuitry for controlling the LEDs 128. The LDM 126 includes a controller, such as an enable circuit 156 and a series of current drivers 158. The enable circuit 156 receives the input signals (P_{bat}, BPP, TURN, PRNDL, and GATE) from the driver controls 138 and the lift gate system 150. The enable circuit 56 includes discrete components (not shown) for enabling the current drivers 158 based on the input signals. In the illustrated embodiment, the enable circuit 156 is configured to enable all the current drivers 158 and corresponding LED strings 152 together. However, in other embodiments of the lighting system 120, the enable circuit includes a microprocessor and memory (not shown) and is configured to enable the current drivers 158 and corresponding LED strings 152 individually.

The current drivers 158 (“CD1, CD2 . . . CD10”) are arranged as a group that are connected in parallel for controlling the LED strings 152. By arranging the current drivers 158 as a group, fewer current drivers are needed to control the LEDs 128, as compared to the current drivers 58 shown in FIGS. 3 and 4. For example, as illustrated in FIG. 6, ten current drivers 158 may be used to drive twenty LED strings 152.

The lighting system 120 also includes circuitry for monitoring the performance of the LEDs 128. The lighting system 120 includes a series of open circuit (“OC”) detectors 162, an open circuit detection (“OCD”) enable circuit 163 and a transmitter 164. The OC detectors 162 and the OCD enable circuit 163 are located on the PCB 154, and the transmitter 164 is located in the LDM 126, according to the illustrated embodiment

An OC detector 162 (OCD1, OCD2 . . . OCD10) is connected to each LED string 152 (S1-S20) for monitoring for an open circuit condition within that particular LED string 152. The OCD enable circuit 163 is connected between the enable circuit 156 and the OC detectors 162 for selectively enabling the OC detectors 162 to monitor the LED strings 152 based on input signals. For example, in one embodiment, the OCD enable circuit 163 is configured to enable the OC detectors 162 when the TURN signal is on and the GATE signal indicates that the lift gate is closed. By enabling the OC detectors 162 in response to certain input signals, the lighting system 120 limits the occurrence of LED glow. The transmitter 164 is connected to each OC detector 162, and generates a signal (OUTAGE) that indicates that at least one of the LED strings 152 has an open circuit condition. The transmitter 164 may provide the OUTAGE signal to other vehicle controllers.

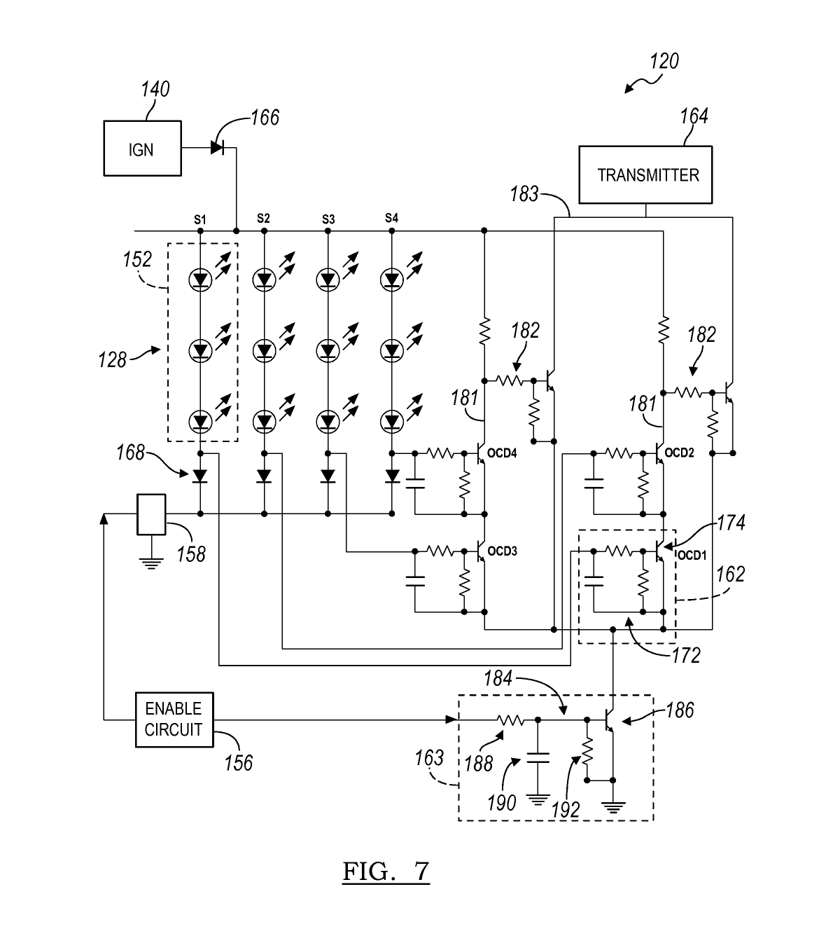

FIG. 7 is a circuit diagram illustrating a portion of the lighting system of FIG. 6. The battery power (P_{bat}) is provided to the LED strings 152 through an input diode 166. LED strings S1, S2, S3 and S4 are illustrated in FIG. 4. The input diode 166 prevents current from flowing back towards the battery 148.

The current drivers 158 maintain a generally constant current through the LED strings 152. Each current driver 158 may include a switch (e.g., a transistor) and a resistor, such as the current drivers 58 shown in FIG. 4. The enable circuit 156 is connected to each current driver 158 to control or “drive” a constant current through each LED string 152.

The OC detector 162 monitors an electrical characteristic (e.g., current or voltage) of its corresponding LED string 152 for a discontinuity, such as an open circuit condition. An open circuit condition indicates that no current is flowing through the LED string 152, and therefore the LEDs 128 of the LED string 152 are not emitting any light. An isolation diode 168 is connected between each LED string 152 and the current driver 158. Each OC detector (OCD1-OCD4) is connected to a node of a corresponding LED string (S1-S4) between the cathode of the last LED 128 and an anode of the isolation diode 168. The isolation diode 168 isolates each OC detector 162 from the other LED strings 152 such that the OC detector 162 monitors the electrical characteristics of that individual LED string 152. The OC detector 162 includes a low pass filter, such as an RC circuit 172 and a switch, such as a transistor 174.

The RC circuit 172 functions as a low pass filter and as a bias for the transistor 174, according to one or more embodiments. The RC circuit 172 includes a capacitor 176, a first resistor 178 and a second resistor 180. The RC circuit 172 is connected between the LED string 152 and the base of the transistor 174. The OC detectors 162 are arranged in pairs of series connected circuits. For example, the collector of the transistor 174 of OCD1 is connected to the emitter of the transistor 174 of OCD2. The pairs of OC detectors (e.g., OCD1 and OCD2) are connected to a shared line 181, such that the transistors 174 collectively provide a NAND gate.

Each pair of OC detectors 162 are connected to an inverter circuit 182. The inverter circuit 182 inverts the NAND gate of each pair of transistors 174 to provide an AND gate. An AND gate is a logic gate which produces an output that is True only if all its inputs are True. A HIGH (True) output results only if all of the inputs to the gate are HIGH (True); and a LOW (False) output if any of the inputs are LOW (False). The inverter circuit 182 also limits current leakage through other circuitry of the lighting system 120. The common line 183 is maintained at a low voltage (LOW) when none of the OC detectors detect an open circuit. However, if any of the OC detectors (OCD1-OCD4) detect an open circuit in their respective LED string (S1-S4), then the transistor 174 of that OC detector 162 will open and cause the shared line 181 to float to a low voltage (LOW), which is inverted to a high voltage (HIGH) by the inverter 182, which causes the common line 183 to float to a high voltage (HIGH). Thus, each OC detector 162 is configured to monitor the current associated with a corresponding LED string 152 and to generate an output signal (LOW voltage) that is indicative of a discontinuity within the LED string 152 in response to the current being less than a threshold value (e.g., 50 μA), or being equal to approximately zero amps. Then the inverter 182 inverts the signal from LOW to HIGH. The transmitter 164 is connected to the common line 183, and the transmitter 164 will provide a corresponding OUTAGE signal when the common line 183 is high.

The enable circuit 156 and the OCD enable circuit 163 selectively enable the OC detectors 162 to limit the occurrence of LED glow. The OCD enable circuit 163 controls a ground path for the OC detectors 162. The enable circuit 156 disables the OC detectors 162 by controlling the OCD enable circuit 163 to disconnect the ground path, such that no current flows through the LED string 152 (e.g., S1) and through the RC circuit 172 of the corresponding OC detector (e.g., OCD1) to ground.

The OCD enable circuit 163 includes an RC circuit 184 and a switch 186, such as a transistor. The RC circuit 184 includes a first resistor 188, a capacitor 190, and a second resistor 192 that is connected in parallel with the capacitor 190. The OCD enable circuit 163 enables the OC detectors 162 by providing a ground path through the transistor 186. The OCD enable circuit 163 disables the OC detectors 162 by opening the transistor 186, and disconnecting the ground path, thereby causing the OC detectors 162 to “float” and not draw current through the LEDs 128.

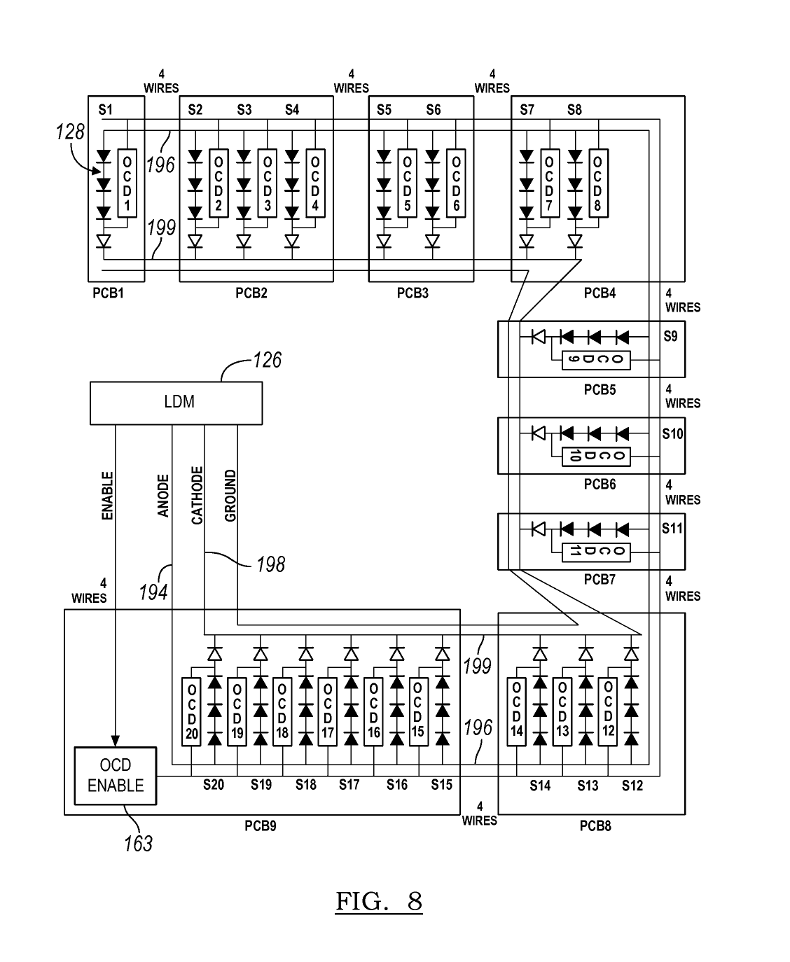

With reference to FIG. 8, the LEDs 128 may be distributed amongst multiple circuit boards 154 in a daisy chain configuration. Multiple small PCBs may be easier to position or package within a contoured lamp (e.g., the RCL 24 of FIG. 1), than a large planar PCB. FIG. 8 depicts the twenty LED strings (S1-S20) of FIG. 6, distributed amongst nine PCBs (PCB1-PCB9). The PCBs 154 include different numbers of LED strings 152. For example, in the illustrated embodiment, PCB1 includes one LED string (S1), and PCB9 includes six LED strings (S15-S20). Distributing the LED strings 152 amongst multiple PCBs accommodates large and/or contoured lamp assemblies. Such distributed PCBs 154 also increase the number of wires and associated costs, for interconnecting the PCBs 154 to the LDM 126. However, by locating the OC detectors 162 on the PCBs 154 the number of wires may be reduced, as compared to the configuration illustrated in FIG. 5.

For example, a power line 194 provides P_{bat} to the anode of the first LED 128 of each LED string 152. A power line jumper wire 196 connects each PCB 154 to an adjacent PCB 154. Therefore eight additional power line jumper wires 196 are used to connect the power line 194 between the LDM 126 and the nine PCBs shown in FIG. 8, as compared to the common PCB shown in FIG. 6.

A return line 198 is connected between the LDM 126 and the cathode (“C1-C20”) of the last LED 128 of each LED string 152 (S1-S20). Since the OC detectors 162 are located on the PCBs 154, a common return line 198 is connected to each cathode. A return line jumper wire 199 connects each PCB to the adjacent PCB. The return line 198 for C1 (LED string S1) which is located on PCB1, includes eight additional return line jumper wires 199 as compared to the configuration shown in FIG. 6. However, the return line 198 for C2 (LED string S2) which is located on PCB2, includes shares the same return line jumper wires 199 as those for C2. For illustrative purposes, the total number of jumper wires 196, 199 between each pair of adjacent PCBs is denoted as “#Wires” in FIG. 8. Thus by distributing the LEDs 128 over nine PCBs, thirty-two additional jumper wires 196, 199 are needed, as compared to the common PCB configuration shown in FIG. 6. However, a lighting system 120 having such remote OC detectors 162, requires fewer jumper wires than a lighting system having local OC detectors that are located in the LDM, such as the lighting system 20 illustrated in FIG. 5, which included seventy-one jumper wires.

As such, the lighting system 120 provides advantages over existing systems by monitoring the LEDs 128 for discontinuities (e.g., an open circuit condition) using detectors 162 that are selectively enabled. By disabling the detectors 162 when they are not in use, the lighting system 120 reduces a potential LED glow condition in which the LEDs 128 may emit light even when they are not “enabled” by the current drivers 158. Further, the detectors 162 are mounted in proximity to the LEDs 128 and remote from the controller 156 to reduce wiring content (jumper wires 196, 199).

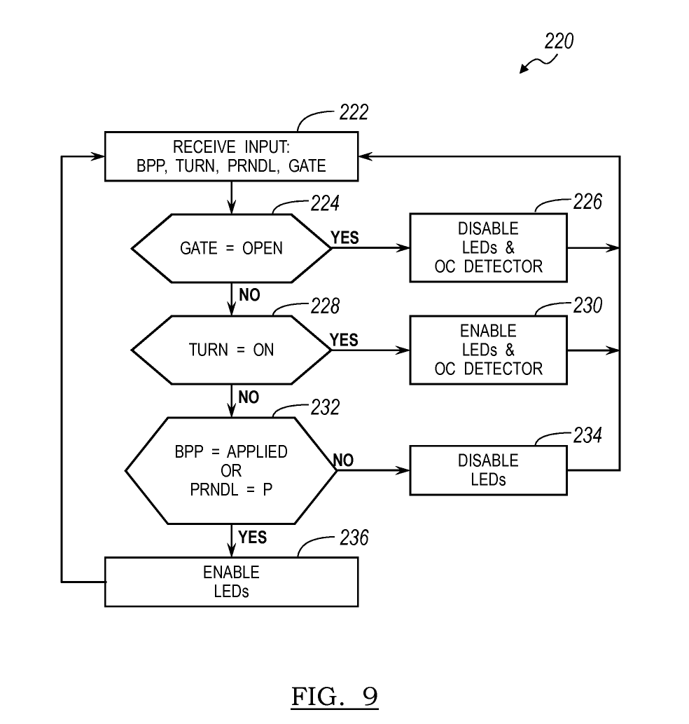

With reference to FIG. 9, a method for monitoring the LEDs is illustrated in accordance with one or more embodiments and is generally referenced by numeral 220. The control logic of the method 220 is provided by the enable circuit according to one or more embodiments.

In block 222, the enable circuit receives input signals (BPP, TURN, PRNDL and GATE) that are indicative of a brake pedal position, a turn signal status, a gear selection and a lift gate position, respectively. At operation 224, the enable circuit evaluates the GATE signal to determine if the lift gate position is open. If the determination at operation 224 is positive (e.g., GATE=OPEN), then the enable circuit proceeds to block 226 and disables the LEDs and disables the OC detectors. The enable circuit may disable the LEDs by controlling the current drivers to open or minimize current through their corresponding LED string. The enable circuit may disable the OC detectors by controlling the transistors of the OCD enable circuits to open, thereby disconnecting the OC detectors from ground. After block 226, the enable circuit returns to block 222. If the determination at operation 224 is negative (e.g., GATE≠OPEN), then the enable circuit proceeds to operation 228.

At operation 228 the enable circuit evaluates the TURN signal to determine if the turn signal status is on. If the determination at operation 228 is positive (e.g., TURN=ON), then the enable circuit proceeds to block 230 and enables the LEDs and enables the OC detectors. The enable circuit may enable the LEDs by controlling the current drivers to control the current through their corresponding LED strings at a constant value. The enable circuit may enable the OC detectors by controlling the transistors of the OCD enable circuits to close, thereby connecting the OC detectors to ground. After block 230, the enable circuit returns to block 222. If the determination at operation 228 is negative (e.g., TURN≠ON), then the enable circuit proceeds to operation 232.

At operation 232 the enable circuit evaluates the BPP and PRNDL signals to determine if either the brake pedal is applied, or if the gear selection is park. If the determination at operation 232 is negative (e.g., BPP≠APPLIED and PRNDL≠P), then the enable circuit proceeds to block 234 and disables the LEDs. After block 234, the enable circuit returns to block 222. If the determination at operation 232 is positive (e.g., BPP=APPLIED or PRNDL=P), then the enable circuit proceeds to block 236 and enables the LEDs. After block 236, the enable circuit returns to block 222.

While the best mode has been described in detail, those familiar with the art will recognize various alternative designs and embodiments within the scope of the following claims. Additionally, the features of various implementing embodiments may be combined to form further embodiments of the invention. While various embodiments may have been described as providing advantages or being preferred over other embodiments or prior art implementations with respect to one or more desired characteristics, those of ordinary skill in the art will recognize that one or more features or characteristics may be compromised to achieve desired system attributes, which depend on the specific application and implementation. These attributes may include, but are not limited to: cost, strength, durability, life cycle cost, marketability, appearance, packaging, size, serviceability, weight, manufacturability, ease of assembly, etc. The embodiments described herein that are described as less desirable than other embodiments or prior art implementations with respect to one or more characteristics are not outside the scope of the disclosure and may be desirable for particular applications. Additionally, the features of various implementing embodiments may be combined to form further embodiments of the invention.

What is claimed is:

1. A lighting system comprising:
a lamp assembly for being positioned on an external surface of a vehicle;
a plurality of devices disposed within the lamp assembly and configured to emit light in response to receiving electrical power from a power source;
a detector coupled to the plurality of devices and configured to monitor an electrical characteristic associated with the plurality of devices and to generate an output signal indicative of a discontinuity within the plurality of devices in response to the electrical characteristic being less than a threshold value; and
a controller coupled to the detector, the controller being configured to receive input indicative of a turn signal status and a rear closure position and to enable the detector in response to the rear closure position being closed and the turn signal status being on.

2. The lighting system of claim 1 wherein the controller is further configured to disable the detector in response to the rear closure position being open.

3. The lighting system of claim 1 further comprising:
a switch connected between the detector and ground for enabling and disabling the detector;
wherein the controller is further configured to control the switch to enable and disable the detector.

4. The lighting system of claim 3 wherein the switch is further configured to disable the detector by opening and disconnecting the detector from ground, thereby disrupting a ground path through the detector.

5. The lighting system of claim 1 wherein the lamp assembly is configured for being positioned on a rear closure of a vehicle, the rear closure being operable to open and close.

6. The lighting system of claim 1 further comprising:
a driver communicating with the controller and connected to the plurality of devices for controlling the electrical power provided to the plurality of devices;
wherein the controller is further configured to disable the driver in response to the rear closure position being open.

7. The lighting system of claim 1 further comprising:
a series of circuit boards disposed within the lamp assembly;
wherein the plurality of devices further comprise a plurality of LED strings, the plurality of LED strings being mounted to the series of the circuit boards and remote from the controller.

8. The lighting system of claim 7 wherein the detector further comprises a plurality of detectors, each detector being mounted to one of the series of circuit boards and remote from the controller.

9. A lighting system comprising:
a series of circuit boards for being positioned about a vehicle;
a plurality of LED strings mounted to the series of circuit boards;
a controller connected to the plurality of LED strings in a daisy chain configuration; and
a plurality of detectors mounted to the series of circuit boards and remote from the controller, each detector being coupled to one of the plurality of LED strings for monitoring an electrical characteristic;
wherein the controller is configured to receive input indicative of a rear closure position and to disable the plurality of detectors in response to the rear closure position being open.

10. The lighting system of claim 9 further comprising:
a switch connected between the plurality of detectors and ground for enabling and disabling each of the plurality of detectors;
wherein the controller is further configured to control the switch to enable and disable the plurality of detectors.

11. The lighting system of claim 9 wherein the controller is further configured to:
receive input indicative of a turn signal status; and
enable the plurality of detectors in response to the rear closure position being closed and the turn signal status being on.

12. The lighting system of claim 9 further comprising a driver communicating with the controller and connected to the plurality of LED strings for controlling electrical power provided to the plurality of LED strings.

13. The lighting system of claim 12 wherein the controller is further configured to disable the driver in response to the rear closure position being open.

14. The lighting system of claim 13 wherein the controller is further configured to:
receive input indicative of a brake pedal position, a turn signal status, and a gear selection; and
enable the driver in response to the rear closure position being closed, and at least one of the brake pedal position being applied, the turn signal status being on, and the gear selection being park.

15. A lighting system comprising:
a plurality of LEDs configured to emit light in response to receiving electrical power from a power source;
a detector coupled to the plurality of LEDs and configured to monitor an electrical characteristic associated with the LEDs and to generate an output signal indicative of a discontinuity within the plurality of LEDs in response to the electrical characteristic being less than a threshold value; and
a controller coupled to the detector, the controller being configured to receive input indicative of a rear closure position, and to disable the detector in response to the rear closure position being open.

16. The lighting system of claim 15 wherein the controller is further configured to:
receive input indicative of a turn signal status; and
enable the detector in response to the rear closure position being closed and the turn signal status being on.

17. The lighting system of claim 15 further comprising:
a driver communicating with the controller and connected to the plurality of LEDs for controlling the electrical power provided to the plurality of LEDs;
wherein the controller is further configured to disable the driver in response to the rear closure position being open.

18. The lighting system of claim 17 wherein the controller is further configured to:
receive input indicative of a brake pedal position, a turn signal status, and a gear selection; and
enable the driver in response to at least one of the brake pedal position being applied, the turn signal status being on, and the gear selection being park.

19. The lighting system of claim 15 further comprising:
a switch connected between the detector and ground for enabling and disabling the detector;
wherein the controller is further configured to control the switch to enable and disable the detector.

20. The lighting system of claim 15 further comprising:
a series of circuit boards;
wherein the plurality of LEDs further comprise a plurality of LED strings, the plurality of LED strings being mounted to the series of the circuit boards and remote from the controller; and
wherein the detector further comprises a plurality of detectors, each detector being mounted to one of the series of circuit boards and remote from the controller.
